(19) United States
(12) Patent Application Publication
(10) Pub. No.: US 2018/0219812 A1
(43) Pub. Date: Aug. 2, 2018

(54) MOBILE APP MESSAGING PLATFORM SYSTEM

(71) Applicant: Damion Delanno Hanson, Burnaby (CA)

(72) Inventor: Damion Delanno Hanson, Burnaby (CA)

(21) Appl. No.: 15/886,758

(22) Filed: Feb. 1, 2018

Related U.S. Application Data
(60) Provisional application No. 62/453,080, filed on Feb. 1, 2017.

(51) Int. Cl. H04L 12/58; H04W 4/12; H04L 29/06

(52) U.S. Cl. CPC H04L 51/046; H04L 63/04; H04W 4/12; H04L 51/10

(57) ABSTRACT

A mobile app messaging platform system including an electronic mobile device a software interface, a plurality of messages, a server, a user profile, a check status function, a plurality of post parameters, a post-pending function, and a post of the plurality of messages function. The mobile app messaging platform system provides a private and confidential messaging platform. Messages may be selectively concealed on user devices and revealed only when touched. Mobile app messaging platform system maintains privacy and confidentiality when messaging on an electronic device in a public area.

### CROSS REFERENCE TO RELATED APPLICATION

The present application is related to and claims priority to U.S. Provisional Patent Application No. 62/453,080 filed Feb. 1, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of mobile applications and more specifically relates to messaging platforms.

### 2. Description of Related Art

A mobile app is a computer program designed to run on smartphones, tablet computers and other mobile devices. Mobile apps were originally offered for general productivity and information retrieval, including email, calendar, contacts, and stock market and weather information. However, public demand and the availability of developer tools drove rapid expansion into other categories, such as mobile games, factory automation, GPS and location-based services, banking, order-tracking, ticket purchases and recently mobile medical apps. The explosion in number and variety of apps made discovery a challenge, which in turn led to the creation of a wide range of review, recommendation, and curation sources, including blogs, magazines, and dedicated online app-discovery services. Many new apps are desirable to provide convenient solutions to the users.

Texting (and sending images and/or videos along with text) has become the primary mode in which mobile electronic devices are being used to communicate. One advantage of texting vs talking on a smartphone is that texting is more private than talking, and so texting can be performed more discretely in situations where other people are nearby, such as in meetings. However, a disadvantage of existing text messaging services is that the text messages can be read by people situated nearby, e.g., by people sitting next to you, or by people “looking over your shoulder”. A suitable solution is desired to avoid the above-mentioned problem.

U.S. Pub. No. 2006/0085761 to Jay Allen relates to a text masking provider. The described text masking provider includes a system that facilitates masked data entry in an edit control is provided. More particularly, the invention can include a mask engine component that facilitates determination of a valid character from an input of one or more characters with respect to a defined format. In other words, the mask engine can compare an input character to a predefined acceptable format. An interface component that facilitates employment of the mask engine with disparate types of edit controls is also provided. The subject invention can isolate masking functionality as a service that can be interfaced into any desired edit control. For example, the masking service can be interfaced into controls including, but not limited to, a text box, a combo box, a rich edit, a list view and a cell in a data grid or the like.

### BRIEF SUMMARY OF THE INVENTION

In view of the foregoing disadvantages inherent in the known mobile applications art, the present disclosure provides a novel mobile app messaging platform system. The general purpose of the present disclosure, which will be described subsequently in greater detail, is to provide a private and confidential messaging platform.

A mobile app messaging platform system is disclosed herein. The mobile app messaging platform system includes an electronic mobile device a software interface, a plurality of messages, a server, a user profile, a check status function, a plurality of post parameters, a post-pending function, and a post of the plurality of messages function. The software interface is located on a mobile application on the electronic mobile device. The mobile application messaging platform system is configured to allow confidential communication between a plurality of users. The software interface includes an application configured to allow the plurality of users to interact with each other over a network.

The present invention, mobile app messaging platform system entitled, “Peeqchat”, provides a private and confidential messaging platform. Messages may be concealed by default on each user's device and revealed only when touched. Peeqchat maintains privacy and confidentiality when messaging on an electronic device around other people. It provides private messaging on both sides of a conversation, as messages appear concealed by default. The app makes it difficult to screenshot conversations from within the application or take a picture of the conversation.

Privacy is increased while using messaging by providing a mobile messaging user with a capability of concealing or masking the contents of a message. Messages thereby concealed may then be selectively viewed and individually viewed by pressing and holding one's finger to the screen on the message placeholder (i.e., blank message bubble) and when holding is released the message returns to a hidden state. When the user taps two or more times on the message placeholder, the message reveals for a predetermined time, usually a few seconds, and then the message returns to a hidden state. Mobile app messaging platform system provides privacy while messaging in public or when others might be eavesdropping on a conversation. A general aspect of the invention is a method for providing enhanced message privacy when exchanging messages using a messaging device having a touchscreen.

A method of using mobile app messaging platform system is also disclosed herein. The method of using mobile app messaging platform system may comprise the steps of: providing a mobile application messaging platform system, the mobile application messaging platform system having an electronic mobile device; a software interface, the software interface being located on a mobile application on the electronic mobile device; a plurality of messages; a server; a user profile; a check status function; a plurality of post parameters; a post-pending function; a post of the plurality of messages function; and the mobile application messaging platform system is configured to allow confidential communication between a plurality of users; and pressing and holding a finger of a user to a touchscreen on the electronic mobile device to read at least one of the plurality of messages. Releasing the finger of the user allows for the at least one of plurality of messages to return to a hidden state. Tapping two or more times on the at least one of plurality of messages allows for a reveal of the at least one of plurality of messages for a predetermined amount of time before returning to a hidden state.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a mobile app messaging platform system, constructed and operative according to the teachings of the present disclosure.

FIG. 1 is a flow diagram of the mobile app messaging platform system, according to an embodiment of the disclosure.

FIG. 2 is a screen view of the mobile app messaging platform system of FIG. 1, according to an embodiment of the present disclosure.

FIG. 3 is a screen view of the mobile app messaging platform system of FIG. 1, according to an embodiment of the present disclosure.

FIG. 4 is a screen view of the mobile app messaging platform system of FIG. 1, according to an embodiment of the present disclosure.

FIG. 5 is a screen view of the mobile app messaging platform system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to mobile applications and more particularly to a mobile app messaging platform system as used to improve the use of messaging platforms.

The present invention provides a unique method of revealing messages and covers or shows messages based on eye movements using the devices camera(s) or sensor(s). Messages also support voice interaction, touch/motion/shake gesture patterns to trigger show/hide action(s) and/or any other action(s) or series of actions.

A user is able to access the mobile app messaging platform system software interface through an electronic mobile device with internet connectivity. Software interface refers to the program or application the mobile app messaging platform system user uses to interact with other users on the mobile app messaging platform system network, and access the various functions and features available through the mobile app messaging platform system mobile app. Message content describes any client-entered data in the mobile app messaging platform system mobile app and/or stored in the mobile app messaging platform system server. Messages may represent text, images, audio, video, or any other type of supported media.

The server represents a primary computer server system that houses all content and data pertaining to the mobile app messaging platform system network, including client content and mobile app messaging platform system information. A user profile describes a user's personal hub for their activity on mobile app messaging platform system. A user profile contains information such as the identity of the user, and messages they have written and received. Check status includes a series of algorithmic functions that detects and manages the connectivity of the user to both the internet and the mobile app messaging platform system network. Post-parameters include a series of options where the user may select what filters and settings they wish to add to their content, such as the number of time a post may be viewed before becoming inaccessible, the time of day a post can be viewed, password protect post, what media they wish to upload along with their post, etc.

Post pending comprises a series of algorithmic functions that filters content through the mobile app messaging platform system posting criteria before uploading onto the mobile app messaging platform system server. These criteria may vary; however, it can include functions such as verifying the client's account, verifying the mobile app messaging platform system server is online, and ensuring user content is free of inappropriate content. Post message/content is a function of the mobile app messaging platform system software interface that uploads client created content onto the mobile app messaging platform system server along with any preselected settings or filters.

The system of programs and components allows mobile app messaging platform system users to perform and communicate in real-time with other users based on invitation and request. Each new mobile app messaging platform system user is required to create an account with mobile app messaging platform system or log in through an existing service (such as through a FACEBOOK or GMAIL account, phone number sms verification) in order to gain access to its features. Each account is used to represent the individual and will contain data such as a user's login information, general identifiers (such as name, profile picture, and contact details), and the user's activity on mobile app messaging platform system. This information will be visible to the user themselves as well as intended chat recipient(s). As the user posts content to mobile app messaging platform system, or activates other features, their activities are stored on the mobile app messaging platform system servers and/or locally on the user's mobile device.

Message content posted onto mobile app messaging platform system may be in any form of digital media compatible with the mobile app messaging platform system, including text, images, audio and video files.

Agreement message(s) may be provided. These message(s) requires 2 or more parties to mutually agree on the terms of the message(s), the message will then be persistently stored on each party account even if one or more parties change device(s), until there is a mutual agreement among the parties for the agreement/message to no longer be binding or certain pre-existing condition(s) have been met (e.g., expired), then the message can be deleted/archived and will no longer remain persistent.

Before message content is posted on mobile app messaging platform system server via the software interface, both the user and their content is algorithmically checked for compatibility and security reasons. This examination includes checking the user's status, ensuring proper authorization as a mobile app messaging platform system user, registration to the mobile app messaging platform system network, connectivity to the internet, and that created message content is compatible with the mobile app messaging platform system. The ‘check status’ functionality operates continuously and systematically as the user uses mobile app messaging platform system to safeguard mobile app messaging platform system integrity and the user experience.

Mobile app messaging platform system offers a variety of post parameters for users to make message content more relevant and accessible to the mobile app messaging platform system network. Through these settings, users can determine who may view their posted content, whether it be a specified group of other individual mobile app messaging platform system users. Additional post parameters/settings may include but not limited to: forwarding message content to other mobile app messaging platform system users; adding unique protection for individual message content (such as password, fingerprint, or facial recognition); setting limit on the number of views per individual message content before the message content becomes no longer available to its recipient(s) (such as in a group setting, the first ‘x’ number of unique individual user views among the recipients collectively; or in an individual setting, the first ‘x’ number of views of the content by the recipient; specify timeframe during which the message content can be viewed by the recipient(s); specify date and time message content should be sent to recipient(s); adding expiration to message content after which the message content will no longer be available for viewing; retraction or replacing of unviewed message content; save or favorite specific message content; filter or search existing message content; specify conditional action(s) recipient should perform to view message content, otherwise another message content may appear as defined by message content sender; block message content from specific users; update profile information and purchase effects for profile image; specify delivery notification preference for new message content received; partial message content reveal determined by the on-screen location touched by the user or relative to that location touched by the user, will be used to determine which specific area of the message content revealed.

Message(s) are available for viewing until a specified number of different users have been reached. (e.g., message no longer available after the first 10 users have viewed it, etc.). Individual message(s) are revealed upon receipt and/or all messages revealed for a predetermined amount of time and/or based on message content, and/or the message state and/or the state of another message(s), and/or the message sender, and/or device motion/shake/movement, and/or an algorithm for determining the user's average reading speed, afterwards the message will hide or delete depending on parameters. Message(s) may be read aloud (e.g., by device's voice assistant) on delivery or based on user gesture, touch, voice command or any other user input, while the message(s) are concealed or revealed.

Once the user has created their message content and selected the desired settings, they can then post that message content to the server. Content is examined by mobile app messaging platform system server security systems and algorithms; pending online connection and verification by those systems being before being added to the server. All of these systems and elements operate in conjunction forms the core system and functionality of mobile app messaging platform system.

The outline of each profile image in the form of a solid color/color blend, design, pattern, and/or shape, can be used to denote status, class, group, preference, etc. for such a purchase in any form will be required of the user(s) for the customization.

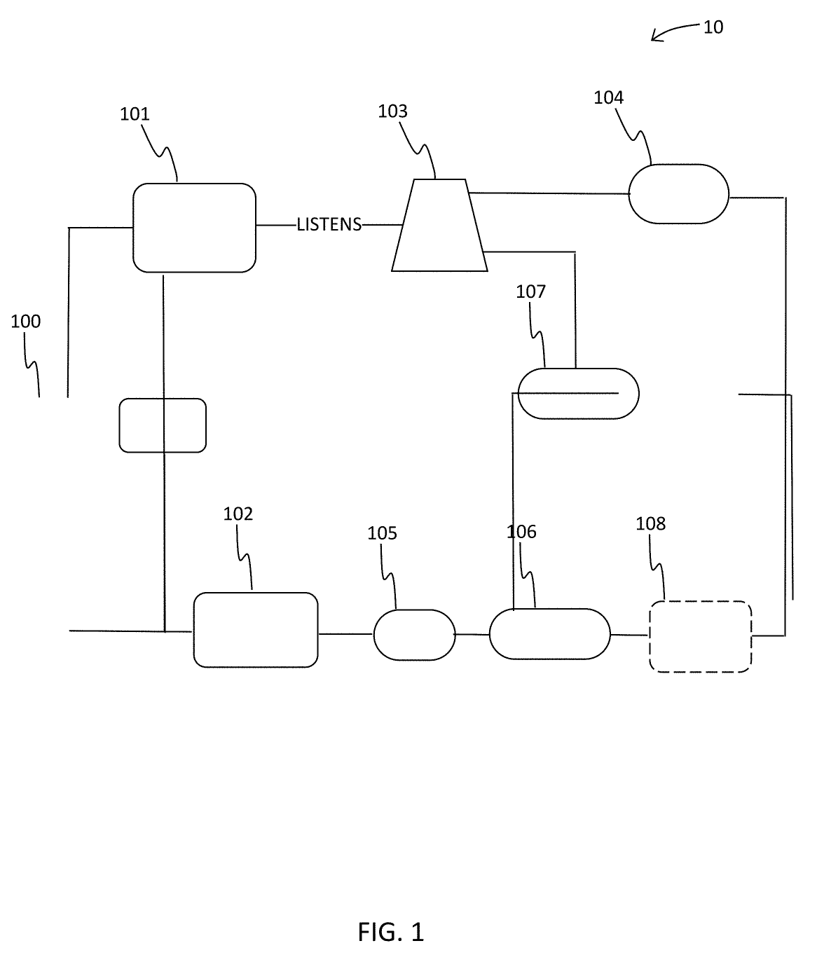

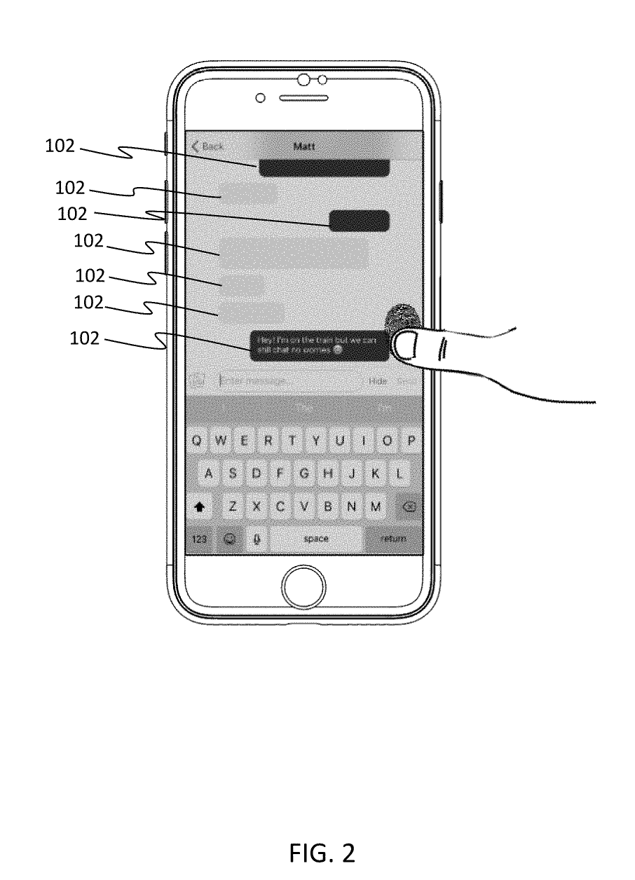

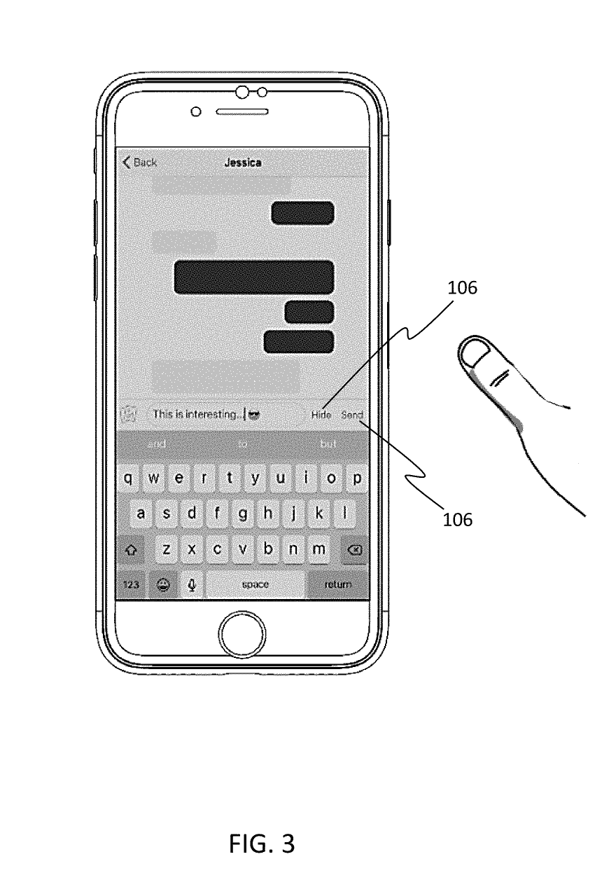

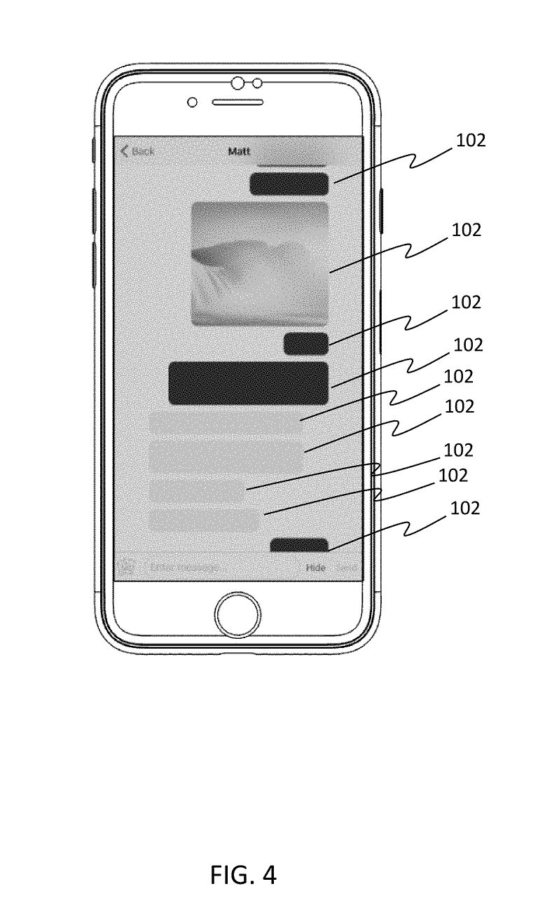

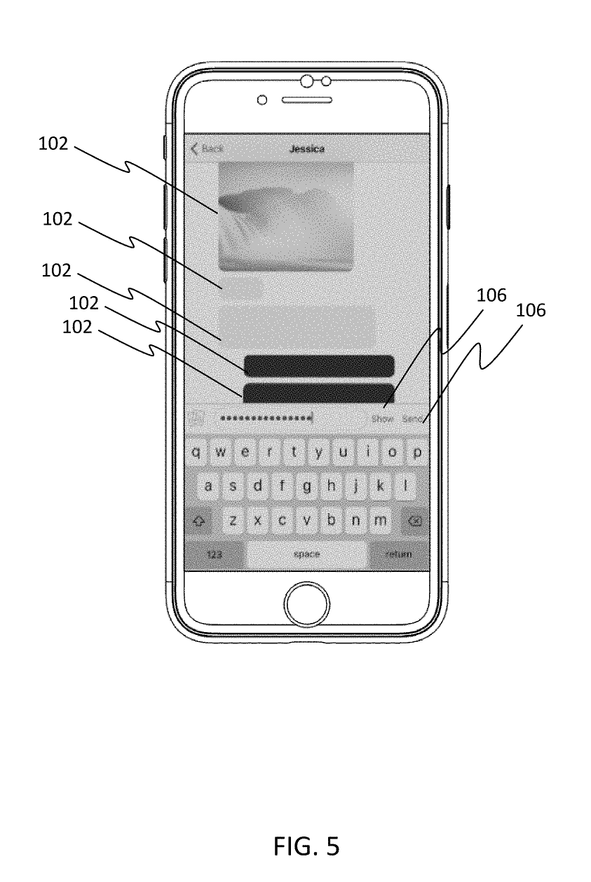

Referring now more specifically to the drawings by numerals of reference, there is shown in FIGS. 1-5, various views of a mobile app messaging platform system 10. FIG. 1 shows a mobile app messaging platform system 10, according to an embodiment of the present disclosure. As illustrated, the mobile app messaging platform system 10 may include an electronic mobile device 100 a software interface 101, a plurality of messages 102, a server 103, a user profile 104, a check status function 105, a plurality of post parameters 106, a post-pending function 107, and a post of the plurality of messages 108 function. The software interface 101 is located on a mobile application on the electronic mobile device 100. The mobile application messaging platform system is configured to allow confidential communication between a plurality of users. The software interface 101 includes an application configured to allow the plurality of users to interact with each other over a network.

The plurality of messages 102 includes client-entered data. The client-entered data is selected from the group consisting of at least one text, at least one image, and at least one video. The server 103 includes a primary computer server system configured to house network data. The user profile 104 includes a personal hub configured to store an activity of a user. The user profile 104 includes an identity of a user and the plurality of messages 102. The plurality of messages 102 includes written messages. The plurality of messages 102 includes a plurality of received messages.

The check status function 105 includes a series of algorithmic functions configured to detect and manage a connectivity of a user to a network. The plurality of post parameters 106 includes a series of options selected by a user. The series of options includes a predetermined number of times a post may be viewed before becoming inaccessible. The series of options includes a predetermined time of day a post can be viewed. The series of options includes a password-protect-post. The post pending function 107 includes a plurality of algorithmic functions configured to filter the plurality of messages 102. The post of the plurality of messages 108 function is configured to upload the plurality of messages 102.

The method for providing enhanced message privacy may include the steps of: providing a mobile application messaging platform system, the mobile application messaging platform system having an electronic mobile device 100; a software interface 101, the software interface 101 being located on a mobile application on the electronic mobile device 100; a plurality of messages 102; a server 103; a user profile 104; a check status function 105; a plurality of post parameters 106; a post-pending function 107; a post of the plurality of messages 108 function; and The mobile application messaging platform system is configured to allow confidential communication between a plurality of users; and pressing and holding a finger of a user to a touchscreen on the electronic mobile device 100 to read at least one of the plurality of messages 102. Releasing the finger of the user allows for the at least one of plurality of messages 102 to return to a hidden state. Tapping two or more times on the at least one of plurality of messages allows for a reveal of the at least one of plurality of messages 102 for a predetermined amount of time before returning to a hidden state.

It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for mobile app messaging platform system 10 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A mobile app messaging platform system comprising:
an electronic mobile device;
a software interface, said software interface being located on a mobile application on said electronic mobile device;
a plurality of messages;
a server;
a user profile;
a check status function;
a plurality of post parameters;
a post-pending function;
a post of said plurality of messages function; and
wherein said mobile application messaging platform system is configured to allow confidential communication between a plurality of users.

2. The mobile app messaging platform system of claim 1, wherein said software interface includes an application configured to allow said plurality of users to interact with each other over a network.

3. The mobile app messaging platform system of claim 1, wherein said plurality of messages includes client-entered data.

4. The mobile app messaging platform system of claim 3, wherein said client-entered data is selected from the group consisting of at least one text, at least one image, and at least one video.

5. The mobile app messaging platform system of claim 1, wherein said server includes a primary computer server system configured to house network data.

6. The mobile app messaging platform system of claim 1, wherein said user profile includes a personal hub configured to store an activity of a user.

7. The mobile app messaging platform system of claim 1, wherein said user profile includes an identity of a user.

8. The mobile app messaging platform system of claim 1, wherein said user profile includes said plurality of messages.

9. The mobile app messaging platform system of claim 1, wherein said plurality of messages includes written messages.

10. The mobile app messaging platform system of claim 1, wherein said plurality of messages includes a plurality of received messages.

11. The mobile app messaging platform system of claim 1, wherein said check status function includes a series of algorithmic functions configured to detect and manage a connectivity of a user to a network.

12. The mobile app messaging platform system of claim 1, wherein said plurality of post parameters includes a series of options selected by a user.

13. The mobile app messaging platform system of claim 12, wherein said series of options includes a predetermined number of times a post may be viewed before becoming inaccessible.

14. The mobile app messaging platform system of claim 12, wherein said series of options includes a predetermined time of day a post can be viewed.

15. The mobile app messaging platform system of claim 12, wherein said series of options includes a password-protect-post.

16. The mobile app messaging platform system of claim 1, wherein said post pending function includes a plurality of algorithmic functions configured to filter said plurality of messages.

17. The mobile app messaging platform system of claim 12, wherein said post of said plurality of messages function is configured to upload said plurality of messages.

18. A method for providing enhanced message privacy comprising:
providing a mobile application messaging platform system, said mobile application messaging platform system having an electronic mobile device; a software interface, said software interface being located on a mobile application on said electronic mobile device; a plurality of messages; a server; a user profile; a check status function; a plurality of post parameters; a post-pending function; a post of said plurality of messages function; and wherein said mobile application messaging platform system is configured to allow confidential communication between a plurality of users; and
pressing and holding a finger of a user to a touchscreen on said electronic mobile device to read at least one of said plurality of messages.

19. The method of claim 18, wherein releasing said finger of said user allows for said at least one of plurality of messages to return to a hidden state.

20. The method of claim 18, wherein tapping two or more times on said at least one of plurality of messages allows for a reveal of said at least one of plurality of messages for a predetermined amount of time before returning to a hidden state.
